(19) United States
(12) Patent Application Publication
(10) Pub. No.: US 2025/0155269 A1
(43) Pub. Date: May 15, 2025

(54) ULTRASONIC TRANSDUCER AND CLAMP-ON ULTRASONIC FLOWMETER

(71) Applicant: Endress+Hauser Flowtec AG, Reinach (CH)

(72) Inventors: Beat Kissling, Reinach (CH); Quirin Müller, Bättwil (CH)

(21) Appl. No.: 18/839,474

(22) PCT Filed: Feb. 6, 2023
(86) PCT No.: PCT/EP2023/052865

§ 371 Date: Aug. 19, 2024

(30) Foreign Application Priority Data
Feb. 18, 2022 (DE) 10 2022 103 953.6

(51) Int. Cl. G01F 1/66; G01F 1/667; G01F 15/14

(52) U.S. Cl. CPC G01F 1/662; G01F 1/667; G01F 15/14

(57) ABSTRACT

An ultrasonic transducer of a clamp-on ultrasonic flowmeter for measuring a measurement variable of a medium in a measuring tube includes: a transducer element for generating and detecting ultrasonic signals; a housing with a housing chamber in which the transducer element is arranged, wherein the housing has at least two second contact points, which are configured to contact the measuring tube; an extension arm having at least two first contact points, which are configured to contact the measuring tube, wherein the extension arm has a central region, a first end, and a second end opposite the first end, the first end connected to the housing, and the second end configured to mount on the measuring tube, wherein a magnetic device, by which the ultrasonic transducer can be secured to a magnetic measuring tube, is arranged in the central region of the extension arm.

The invention relates to an ultrasonic transducer and a clamp-on ultrasonic flowmeter.

The secure and robust attachment of clamp-on ultrasonic transducers to measuring tubes is a problem that has not yet been completely satisfactorily solved.

For example, as shown in DE102004052489A1, this is achieved using tensioning belts, but this quickly becomes unwieldy, at least with larger measuring tube diameters.

Alternatively, a plurality of magnets is used, which are arranged in spatial proximity to the ultrasonic transducer circumferentially around the ultrasonic transducer, see for example U.S. Pat. No. 8,151,651B1, or parallel to a measuring tube axis, see U.S. Pat. No. 4,735,097.

However, the material costs of magnets are high.

The object of the invention is therefore to propose a simple and robust attachment of a clamp-on ultrasonic transducer by means of a single magnet.

The object is achieved by an ultrasonic transducer in accordance with independent claim 1 and by a clamp-on ultrasonic flowmeter in accordance with independent claim 9.

In accordance with the invention, an ultrasonic transducer of a clamp-on ultrasonic flowmeter for measuring a measurement variable of a medium in a measuring tube comprises:
a transducer element for generating and detecting ultrasonic signals;
a housing with a housing chamber in which the transducer element is arranged;
an extension arm having at least two first contact points which are designed to come in contact with the measuring tube, wherein the extension arm has a central region, a first end and a second end opposite the first end, the first end being connected to the housing,
wherein a magnetic device, by means of which the ultrasonic transducer can be secured to a magnetic measuring tube, is arranged in the central region of the extension arm,
wherein the magnet is arranged between the first contact points and the housing.

In this way, the ultrasonic transducer can be attached securely and stably to a magnetic measuring tube.

In one embodiment, the magnetic device has a magnet and a fastening device, by means of which fastening device the magnet is secured to the extension arm.

For example, such a magnet can comprise neodymium. For example, such a magnet can be designed as a pot magnet.

In one embodiment, the fastening device has a fastening rod, which is inserted at a first end of the fastening rod into a bore of the magnet and is firmly connected to the magnet in the axial direction, the fastening rod running through an opening of the extension arm, wherein a receptacle of the fastening rod, such as a nut, is attached to a second end of the fastening rod and is designed to transmit a force imparted by the magnet to the extension arm.

The connection between the magnet and the fastening rod or the receptacle of the fastening rod and the fastening rod can be made, for example, via a thread, or via a groove engagement connection, via a snap mechanism or similar.

In one embodiment, the first contact points and the second contact points are each arranged mirror-symmetrically to one another with respect to a longitudinal sectional plane of the housing.

In this way, the ultrasonic transducer can be attached particularly securely and stably to a magnetic measuring tube.

In one embodiment, the housing has at least two second contact points which are designed to come in contact with the measuring tube;

A clamp-on ultrasonic flowmeter in accordance with the invention comprises:
at least two ultrasonic transducers in accordance with any of the preceding claims, which are arranged on a magnetic measuring tube;
an electronic measuring/operating circuit for operating the ultrasonic transducers and for detecting measurement signals from the ultrasonic transducers and providing measurement values of a measurement variable,
wherein at least two ultrasonic transducers of different ultrasonic transducers are designed to transmit and receive ultrasonic signals to/from one another, for example in accordance with the transit time or transit time difference principle.

Magnetic measuring tubes can be made of carbon steel, for example.

In one embodiment, a contact point of the magnet on the measuring tube and a contact point of the transducer element on the measuring tube lie in a plane through a measuring tube longitudinal axis.

In one embodiment, the measuring tube has an outer diameter of at least 200 millimeters.

The invention will now be described with reference to exemplary embodiments.

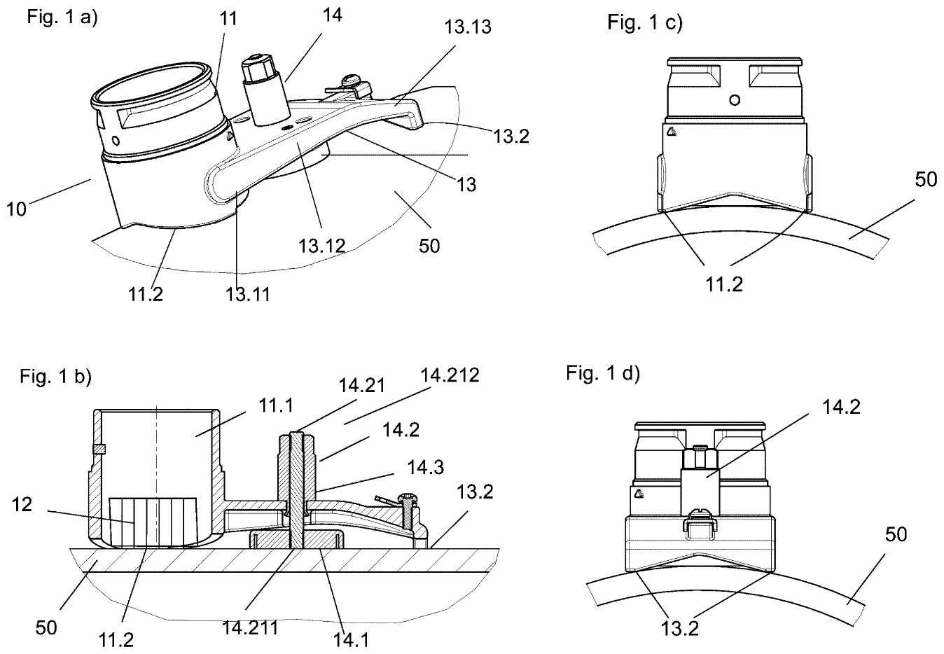

FIGS. 1 a) to 1 d) show different views and a section of an exemplary ultrasonic transducer in accordance with the invention.

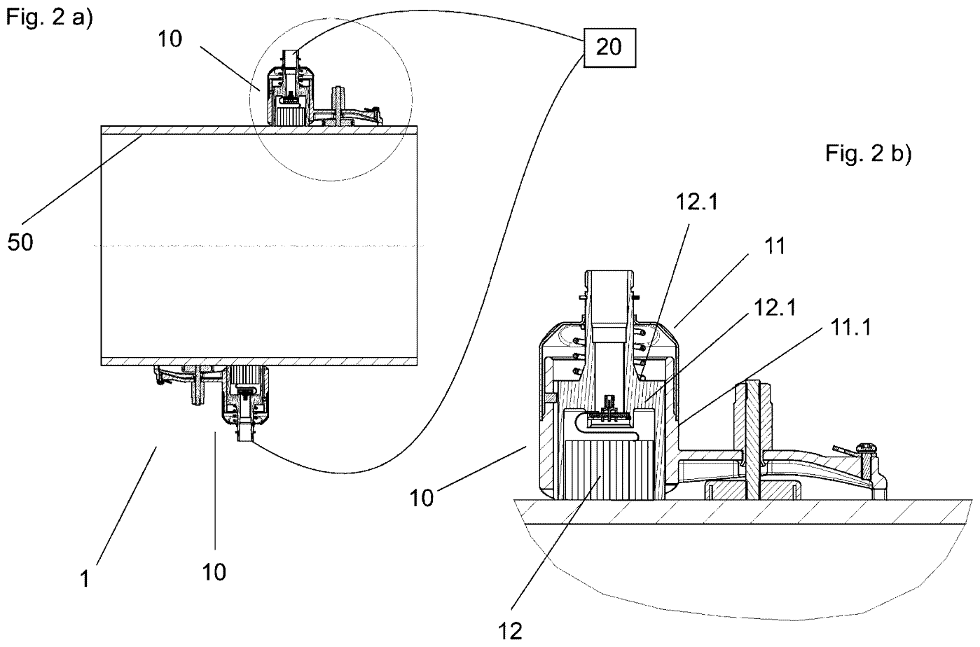

FIG. 2 a) outlines a section through an exemplary clamp-on ultrasonic flowmeter in accordance with the invention and FIG. 2 b) outlines a section through an exemplary ultrasonic transducer in accordance with the invention with a transducer element.

FIG. 1 a) is an oblique view of an exemplary ultrasonic transducer 10 in accordance with the invention arranged on a magnetic measuring tube 50. The ultrasonic transducer has a housing 11 for a transducer element 12, which is arranged in a housing chamber 11.1 of the housing, see also FIG. 1 b). The housing can have first contact points 11.2, as shown here, by means of which it rests on the measuring tube. An extension arm 13 connected to the housing has second contact points 13.2, by means of which the extension arm rests on the measuring tube. As shown here, the housing and extension arm can be formed as a single piece. Alternatively, the extension arm can also be detachably connected to the housing. The extension arm has a first end 13.11 connected to the housing, a central region 13.12 and a second end 13.13, the second contact points being located in the region of the second end. In accordance with the invention, a magnetic device 14 is provided in the central region in order to attach the ultrasonic transducer to the magnetic measuring tube.

As shown in FIG. 1 b), the magnetic device has a magnet 14.1 in contact with the measuring tube 50, wherein preferably a contact line of the magnet on the measuring tube and a contact line of the transducer element on the measuring tube lie in a plane through a measuring tube longitudinal axis. For example, such a magnet can comprise neodymium. For example, such a magnet can be designed as a pot magnet as shown here. A fastening device 14.2 secures the magnet to the extension arm, wherein the fastening device 14.2 has a fastening rod 14.21 which is inserted at a first end 14.211 of the fastening rod into a bore of the magnet and is firmly connected to the magnet in the axial direction, the fastening rod running through an opening of the extension arm, wherein a receptacle of the fastening rod 14.3, such as a nut, is attached to a second end 14.212 of the fastening rod and is designed to transmit a force imparted by the magnet to the extension arm. The connection between the magnet and the fastening rod or the receptacle of the fastening rod and the fastening rod can be made, for example, via a thread, or via a groove engagement connection, via a snap mechanism or similar.

FIG. 1 c) is a front view of the ultrasonic transducer with the first contact points 11.2, and FIG. 1 d) is a rear view with the second contact points 13.2.

In one embodiment, the first contact points 11.2 and the second contact points 13.2 are each arranged mirror-symmetrically to one another with respect to a longitudinal sectional plane of the housing and in particular with respect to a plane through a measuring tube longitudinal axis.

FIG. 2 a) outlines a longitudinal section through an exemplary clamp-on ultrasonic flowmeter 1 with two ultrasonic transducers 10 in accordance with the invention, which are arranged on an outer side of the measuring tube 50, and with an electronic measuring/operating circuit for operating the ultrasonic transducers, for detecting and evaluating measurement signals from the ultrasonic transducers and for providing measurement values.

Ultrasonic transducers of a clamp-on ultrasonic flowmeter can transmit and receive ultrasonic signals to/from one another, for example in accordance with the transit time principle or the transit time difference principle.

FIG. 2 b) outlines an enlarged view of the longitudinal section from FIG. 2 a) through an ultrasonic transducer 10, wherein a transducer element 12 is held in the housing chamber 11.1 of the housing by a mounting bracket.

### LIST OF REFERENCE SIGNS

1 Clamp-on ultrasonic flowmeter
10 Ultrasonic transducer
11 Housing
11.1 Housing chamber
11.2 Second contact points
12 Transducer element
12.1 Mounting bracket for transducer element
13 Extension arm
13.11 First end of the extension arm
13.12 Central region of the extension arm
13.13 Second end of the extension arm
13.2 First contact points
14 Magnetic device
14.1 Magnet
14.2 Fastening device
14.21 Fastening rod
14.211 First end
14.212 Second end
14.3 Receptacle of the fastening rod
20 Electronic measuring/operating circuit
50 Measuring tube

1-12. (canceled)

13. An ultrasonic transducer of a clamp-on ultrasonic flowmeter for measuring a measurement variable of a medium in a magnetic measuring tube, the ultrasonic transducer comprising:
a transducer element configured to generate and detect ultrasonic signals;
a housing including a housing chamber in which the transducer element is disposed;
an extension arm including at least two first contact points, which are configured to contact the measuring tube, wherein the extension arm includes a central region, a first end, and a second end opposite the first end, and wherein the first end is connected to the housing; and
a magnetic device, which includes exactly one magnet, disposed in the central region of the extension arm, wherein the magnetic device is configured to enable the ultrasonic transducer to be secured to a measuring tube,
wherein the magnet of the magnetic device is disposed between the at least two first contact points and the housing.

14. The ultrasonic transducer according to claim 13, wherein the magnetic device includes a fastening device by which the magnet is secured to the extension arm.

15. The ultrasonic transducer according to claim 14, wherein the fastening device includes a fastening rod with a first end, which is inserted into a bore of the magnet and is firmly connected to the magnet in an axial direction, the fastening rod extending through an opening of the extension arm.

16. The ultrasonic transducer according to claim 15, wherein a receptacle of the fastening rod is attached to a second end of the fastening rod and is configured to transmit a force imparted by the magnet to the extension arm.

17. The ultrasonic transducer according to claim 16, wherein the receptacle is a nut.

18. The ultrasonic transducer according to claim 13, wherein the housing includes at least one second contact point, and
wherein the at least two first contact points and the at least one second contact point are each arranged mirror-symmetrically to each other with respect to a longitudinal sectional plane of the housing.

19. The ultrasonic transducer according to claim 18, wherein the at least one second contact point of the housing includes at least two second contact points, which are space apart and configured to contact the measuring tube.

20. The ultrasonic transducer according to claim 13, wherein the magnet and the transducer element each contact the measuring tube along respective contact lines,
wherein the housing and the extension arm are configured such that the respective contact lines are arranged in a plane, which coincides with a longitudinal axis of the measuring tube.

21. The ultrasonic transducer according to claim 20, wherein the magnet has a planar magnetic surface in which its respective contact line runs.

22. A clamp-on ultrasonic flowmeter apparatus, comprising:
at least two ultrasonic transducers according to claim 13, which are arranged on a magnetic measuring tube; and
an electronic measuring/operating circuit configured to operate the at least two ultrasonic transducers, to detect measurement signals from the at least two ultrasonic transducers, and to provide measurement values of a measurement variable of a medium in the measuring tube,
wherein each transducer element of the at least two ultrasonic transducers are configured to transmit and receive ultrasonic signals to/from each other.

23. The apparatus according to claim 22, wherein each transducer element is configured to transmit and receive ultrasonic signals to/from each other according to the transit time principle or the transit time difference principle.

24. The apparatus according to claim 22, wherein the magnet and the transducer element each contact the measuring tube along one contact line, respectively, which contact lines lie in a plane through a longitudinal axis of the measuring tube.

25. The apparatus according to either claim 24, wherein the magnet includes a planar magnetic surface in which its respective contact line extends,
wherein the magnet is oriented such that, when the respective clamp-on ultrasonic flowmeter is arranged on the measuring tube, the planar magnetic surface is directed towards an outer lateral surface of the measuring tube and only the respective contact line contacts the outer lateral surface of the measuring tube such that a remaining portion of the planar magnetic surface is spaced apart from the outer lateral surface.

26. The apparatus according to claim 22, wherein the measuring tube has an outer diameter of at least 200 millimeters.
